(19) United States
(12) Patent Application Publication
(10) Pub. No.: US 2025/0171032 A1
(43) Pub. Date: May 29, 2025

(54) TARGET VEHICLE PARAMETER DETERMINATION

(71) Applicant: The Regents of the University of Michigan, Ann Arbor, MI (US)

(72) Inventor: Sridhar LAKSHMANAN, Belleville, MI (US)

(21) Appl. No.: 18/841,063

(22) PCT Filed: Feb. 24, 2023
(86) PCT No.: PCT/US2023/013824

§ 371 Date: Aug. 23, 2024

Related U.S. Application Data
(60) Provisional application No. 63/313,692, filed on Feb. 24, 2022.

(51) Int. Cl. B60W 40/12; B60W 50/00

(52) U.S. Cl. CPC B60W 40/12; B60W 50/0097; B60L 2240/34; B60W 2510/244; B60W 2520/10

(57) ABSTRACT

A vehicle control system and method of operating a vehicle based on a target value for a vehicle parameter, wherein the target value is determined based on a closed loop feedback process that uses a predicted primary mover performance measure for a primary mover operating point (PMOP) to determine a target value indication. The method includes: obtaining a current vehicle parameter value for the vehicle parameter; determining a current primary mover performance measure for the PMOP; determining the predicted primary mover performance measure for the PMOP; determining the target value indication for the vehicle parameter based on the current primary mover performance measure, the predicted primary mover performance measure, and the current vehicle parameter value for the vehicle parameter; and operating the vehicle according to the target value for the vehicle parameter, wherein the target value for the vehicle parameter is obtained based on the target value indication.

### TECHNICAL FIELD

This disclosure relates to methods and systems for vehicle primary mover control and to determining vehicle parameter values for use in vehicle operation so as to maintain or improve vehicle performance and health.

### BACKGROUND

Vehicles may be operated in various modes depending on priorities of a user or a manufacturer. Generally, vehicle health is a concern, but is difficult to be measured or predicted. Vehicles, such as internal combustion engine (ICE) automobiles or electric vehicles (EVs), include primary propulsion components that spend fuel (gasoline or battery charge) and operation of such components impacts vehicle health.

There is a need to achieve a target or desired primary mover operating point (PMOP) (e.g., engine operating point (EOP)) through setting vehicle parameters that effect this while doing so in a manner that gives attention to vehicle health.

### SUMMARY

In accordance with an aspect of the disclosure, there is provided a method of operating a vehicle based on a target value for a vehicle parameter, wherein the target value is determined based on a closed loop feedback process that uses a predicted primary mover performance measure for a primary mover operating point (PMOP) to determine a target value indication. The method includes the steps of: obtaining a current vehicle parameter value for the vehicle parameter; determining a current primary mover performance measure for the PMOP; determining the predicted primary mover performance measure for the PMOP; determining the target value indication for the vehicle parameter based on the current primary mover performance measure, the predicted primary mover performance measure, and the current vehicle parameter value for the vehicle parameter; and operating the vehicle according to the target value for the vehicle parameter, wherein the target value for the vehicle parameter is obtained based on the target value indication.

According to various embodiments, this method may further include any one of the following features or any technically-feasible combination of some or all of these features:
the determining a current primary mover performance measure for the PMOP step includes determining a current brake specific fuel consumption (BSFC) and wherein the determining a predicted primary mover performance measure for the PMOP step includes determining a predicted BSFC;
the current BSFC is based on a current engine operating point (EOP), which is characterized at least in part by an instantaneous fuel consumption rate (IFCR), an instantaneous engine torque (IET), and/or an instantaneous engine speed (IES);
the determining a predicted primary mover performance measure for the PMOP step includes determining a plurality of predicted BSFCs, wherein each predicted BSFC of the plurality of predicted BSFCs corresponds to a candidate target value, and wherein the target value indication is determined based on at least two of the plurality of predicted BSFCs;
the current primary mover performance measure is based on an electric motor operating point (EMOP);
the EMOP is characterized at least in part by a state of charge (SoC) of a vehicle battery that is used as a primary power source for powering an electric motor that provides propulsion to the vehicle;
the current primary mover performance measure is or is based on miles per gallon equivalent (MPGe) and the predicted primary mover performance measure is a predicted MPGe;
the vehicle parameter is cabin air temperature and wherein the target value for the vehicle parameter is or indicates a target cabin air temperature;
the vehicle parameter is vehicle speed and wherein the target value indication is or indicates a target vehicle speed; and/or
the target value indication is determined based on a gradient of the current primary mover performance measure with respect to the vehicle parameter.

In accordance with another aspect of the disclosure, there is provided a vehicle control system having at least one electronic processor and memory accessible by the at least one electronic processor. The memory stores computer instructions, and the vehicle control system is configured so that, when the at least one electronic processor executes the computer instructions, the vehicle control system carries out a target value determination process of operating a vehicle based on a target value for a vehicle parameter, and wherein the target value is determined based on a closed loop feedback process that uses a predicted primary mover performance measure to determine a target value indication. The target value determination process includes: obtaining a current vehicle parameter value for the vehicle parameter; determining a current primary mover performance measure for the PMOP; determining the predicted primary mover performance measure for the PMOP; determining the target value indication for the vehicle parameter based on the current primary mover performance measure, the predicted primary mover performance measure, and the current vehicle parameter value for the vehicle parameter; and operating the vehicle according to the target value for the vehicle parameter, wherein the target value for the vehicle parameter is obtained based on the target value indication.

According to various embodiments, this vehicle control system may further include any one of the following features or any technically-feasible combination of some or all of these features:
the determining a current primary mover performance measure for the PMOP step includes determining a current brake specific fuel consumption (BSFC) and wherein the determining a predicted primary mover performance measure for the PMOP step includes determining a predicted BSFC;
the current BSFC is based on a current engine operating point (EOP), which is characterized at least in part by an instantaneous fuel consumption rate (IFCR), an instantaneous engine torque (IET), and/or an instantaneous engine speed (IES);
the determining a predicted primary mover performance measure for the PMOP step includes determining a plurality of predicted BSFCs, wherein each predicted BSFC of the plurality of predicted BSFCs corresponds to a candidate target value, and wherein the target value indication is determined based on at least two of the plurality of predicted BSFCs;
the current primary mover performance measure is based on an electric motor operating point (EMOP);
the EMOP is characterized at least in part by a state of charge (SoC) of a vehicle battery that is used as a primary power source for powering an electric motor that provides propulsion to the vehicle;
the current primary mover performance measure is or is based on miles per gallon equivalent (MPGe) and the predicted primary mover performance measure is a predicted MPGe;
the vehicle parameter is cabin air temperature and wherein the target value is or indicates a target cabin air temperature;
the vehicle parameter is vehicle speed and wherein the target value indication is or indicates a target vehicle speed; and/or
the target value indication is determined based on a gradient of the primary mover performance measure with respect to the vehicle parameter.

### BRIEF DESCRIPTION OF THE DRAWINGS

Preferred exemplary embodiments will hereinafter be described in conjunction with the appended drawings, wherein like designations denote like elements, and wherein:

FIG. 1 is a flowchart depicting a method of operating a vehicle based on a target value for a vehicle parameter, according to one embodiment;

FIG. 2 is a diagrammatic depiction of a vehicle set speed control system for which a primary mover performance measure is brake specific fuel consumption (BSFC) and the vehicle parameter is vehicle speed, according to one embodiment;

FIG. 3 is a diagrammatic depiction of a vehicle cabin climate control system for which a primary mover performance measure is BSFC and the vehicle parameter is cabin air temperature (CAT), according to one embodiment;

FIG. 4 is a flowchart depicting a method of operating a vehicle based on a target value for a vehicle parameter, according to one embodiment.

### DETAILED DESCRIPTION

The system and method described herein enables a target value for a vehicle parameter to be determined based on a predicted primary mover performance measure, which may be determined based on a predicted primary mover operating point (PMOP). In some embodiments, the predicted primary mover performance measure may be determined based on the predicted PMOP, which may be a predicted engine operating point (EOP), such as in embodiments where the vehicle has an internal combustion engine (ICE). In such embodiments where the PMOP is an EOP, the primary mover performance measure may be brake specific fuel consumption (BSFC). In another embodiment, the PMOP may be an electric motor operating point (EMOP) for the vehicle. In at least some embodiments, such as those where the PMOP is an EMOP, the primary mover performance measure may be a miles per gallon equivalent (MPGe) and the predicted primary mover performance measure is a predicted MPGe.

According to at least some embodiments, there is provided a method for operating a vehicle based on a target value for a vehicle parameter, wherein the target value is determined based on a closed loop feedback process that uses a predicted primary mover performance measure to determine a target value indication. The method includes: obtaining a current vehicle parameter value for the vehicle parameter; determining a current primary mover performance measure for the PMOP; determining the predicted primary mover performance measure for the PMOP; determining the target value indication for the vehicle parameter based on the current primary mover performance measure, the predicted primary mover performance measure, and the current vehicle parameter value for the vehicle parameter; and operating the vehicle according to the target value for the vehicle parameter, wherein the target value for the vehicle parameter is obtained based on the target value indication.

According to at least some embodiments, there is provided a vehicle control system that includes at least one processor and memory accessible by the at least one processor. In embodiments, the memory stores computer instructions that, when executed by the at least one processor, cause the method above to be carried out by the vehicle control system.

In one embodiment, the method and/or the vehicle control system are implemented using or for a vehicle having an internal combustion engine. In such an embodiment, the vehicle may include various engine sensors and control modules, such as an engine control module (ECM). In some embodiments, any one or more of an instantaneous fuel consumption rate (IFCR), an instantaneous engine torque (IET), and/or an instantaneous engine speed (IES), may be measured by one or more sensors, or may be derived from sensor data obtained by a vehicle sensor. In such embodiments where the vehicle includes an ICE, the primary mover performance measure may be brake specific fuel consumption (BSFC), and may be calculated as follows:

$$BSFC ( t ) = \frac{IFCR ( t ) \frac{743}{3600} [ g / s ]}{P ( t ) [ W ]} \qquad ( 1 )$$

where IFCR(t) is the IFCR for time t, and P(t) is the power for time t, given by:

$$P ( t ) = \frac{2 π}{60} \cdot IES ( t ) [ rads / sec ] \cdot IET ( t ) [ Nm ] \qquad ( 2 )$$

where IES(t) is the IES at time t and IET is the IET at time t.

The engine operating point (EOP) may be defined (or characterized at least in part) by an instantaneous fuel consumption rate (IFCR), an instantaneous engine torque (IET), and/or an instantaneous engine speed (IES), each of which may be expressed as a vector.

The vehicle may include a heating ventilation and air conditioning (HVAC) system that is used to cause the temperature of a cabin, such as a passenger cabin, of the vehicle to be set or maintained at a specified temperature. This is referred to as cabin air temperature (CAT). The CAT may be driven by user command(s) such as via a set temperature selected or otherwise inputted by a vehicle occupant. In some embodiments, a target value for the CAT may be determined and the vehicle then operated according to this value, which may include setting the CAT set point to be the target value.

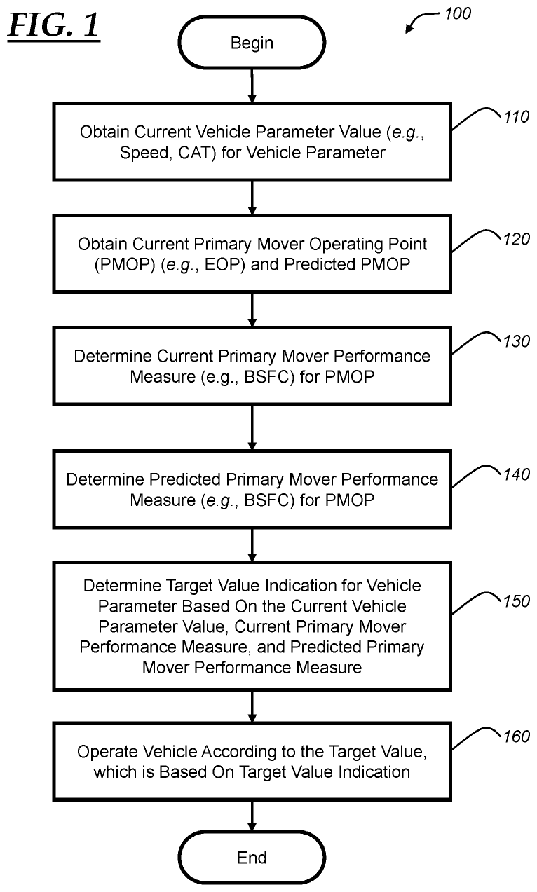

With reference to FIG. 1, there is shown an embodiment of a method 100 of operating a vehicle based on a target value for a vehicle parameter. According to at least some embodiments, the method 100 is carried out by the vehicle control system, which may include one or more processors, such as one or more processors onboard the vehicle. While the steps 110-160 are discussed as being carried out in a particular order, those skilled in the art will appreciate that the steps may be carried out in any suitable and technically-feasible order.

The method 100 begins with step 110, wherein a current vehicle parameter value for the vehicle parameter is obtained. In one embodiment, the method may be used in conjunction with, or as an integral part of, a vehicle cruise control system that regulates vehicle speed according to a set speed selected or otherwise inputted by the vehicle operator. In this case, the vehicle parameter is vehicle speed (longitudinal vehicle speed) and, in such an embodiment, the current vehicle parameter value may be detected by a vehicle speed sensor and specified as miles per hour (MPH) or kilometers per hour (KPH). In another embodiment, the method may be used with or as part of a vehicle climate control (HVAC) system in which a vehicle occupant can select or input a desired (set) temperature to which the vehicle cabin is to be regulated. In this case, the vehicle parameter is cabin air temperature and, in such an embodiment, the current vehicle parameter value may be detected by one or more thermistors or other temperature sensors in or about the cabin, and can be specified as a temperature in Celsius (C) or Fahrenheit (F). In some embodiments, the predicted PMOP is determined based on the current vehicle parameter value for the vehicle parameter. The method 100 continues to step 120.

In step 120, a current PMOP and the predicted PMOP are obtained. As mentioned above, the PMOP may be an EOP and, in such embodiments, the current PMOP is a current EOP, which may be measured or determined based on sensor data from vehicle sensors; estimated based on sensor data of one or more external vehicle parameters; and/or estimated using known EOP estimation techniques, including those employing a deep learning neural network, for example. The predicted PMOP may be based on the current PMOP for time step k and estimated as the predicted PMOP at the next time step k+1. The method 100 continues to step 130.

It should be appreciated that, in some embodiments, a current primary mover performance measure and/or a predicted primary mover performance measure may be calculated directly without actually calculating a current or predicted PMOP (e.g., EOP or EMOP). In such embodiments, step 120 may be omitted and step 130 may include, for example, determining a current primary mover performance measure for the PMOP based on measured IFCR, IES, and IET values, even though a current EOP value itself may have never been calculated/stored in memory.

In step 130, a current primary mover performance measure for the PMOP is determined. In embodiments where the vehicle has an ICE, the current primary mover performance measure may be brake specific fuel consumption (BSFC) at time k. The BSFC may be determined from the EOP (or the IFCR, IES, and IET) using the equation above. In embodiments where the vehicle has an electric motor as a primary mover, the primary mover performance measure may be a primary mover performance measure may be a miles per gallon equivalent (MPGe), which may be determined based on an electric motor operating point (EMOP). The method 100 continues to step 140.

In step 140, a predicted primary mover performance measure for the PMOP is determined. In embodiments where the vehicle has an ICE, the predicted primary mover performance measure may be a predicted BSFC. The predicted BSFC may be determined from the predicted EOP (or the IFCR, IES, and IET) using the equation above, and with using the predicted EOP (which may be comprised of a predicted IFCR, IES, and IET) to determine the predicted BSFC using the equation above. In embodiments where the vehicle has an electric motor as a primary mover, the predicted primary mover performance measure may be a predicted primary mover performance measure may be a predicted MPGe, which may be determined based on a predicted EMOP.

In at least some embodiments, this step includes obtaining a plurality of predicted primary mover performance measures for the PMOP, such as is discussed below in connection with Table 1. For example, a predicted primary mover performance measure, such as a predicted BSFCs, may be determined for each of a plurality of candidate target values, and then the plurality of predicted BSFCs (or a subset thereof) may be used to determine the target value indication. The method 100 continues to step 150.

In step 150, a target value indication for the vehicle parameter is determined based on the current primary mover performance measure, the predicted primary mover performance measure, and the current vehicle parameter value for the vehicle parameter. The target value indication is or indicates the target value. For example, the target value indication may be a vehicle parameter adjustment value indicating a direction and/or extent of adjustment to be made to a current vehicle parameter value. Or, in another example, the target value indication may be the target value.

In at least one embodiment, this step includes employing a gradient function for the predicted primary mover performance measure, such as a gradient for the predicted BSFC, at time step k+1, which may be defined as

$$\frac{∇ P ( k + 1 )}{∇ VP ( k + 1 )} = \frac{P ( k + 1 ) \cdot PMPM ( k )}{( k + 1 ) - VP ( k )} \qquad ( 3 )$$

where PMPM(k) is the primary mover performance measure at time step k, [symbol] (k+1) is the predicted or estimated primary mover performance measure at time step k+1, VP(k) is the vehicle parameter value for the vehicle parameter VP at time step k, and [symbol] (k+1) is the estimated or predicted vehicle parameter value for time step k+1. In some embodiments, the predicted or estimated primary mover performance measure is calculated based on the predicted primary mover operating point, which may be determined using, for example, the estimation methodology described in Kolachalama, S. and Lakshmanan, S., “Using Deep Learning to Predict the Engine Operating Point in Real-Time,” SAE Technical Paper 2021-01-0186, 2021, doi:10.4271/2021-01-0186.

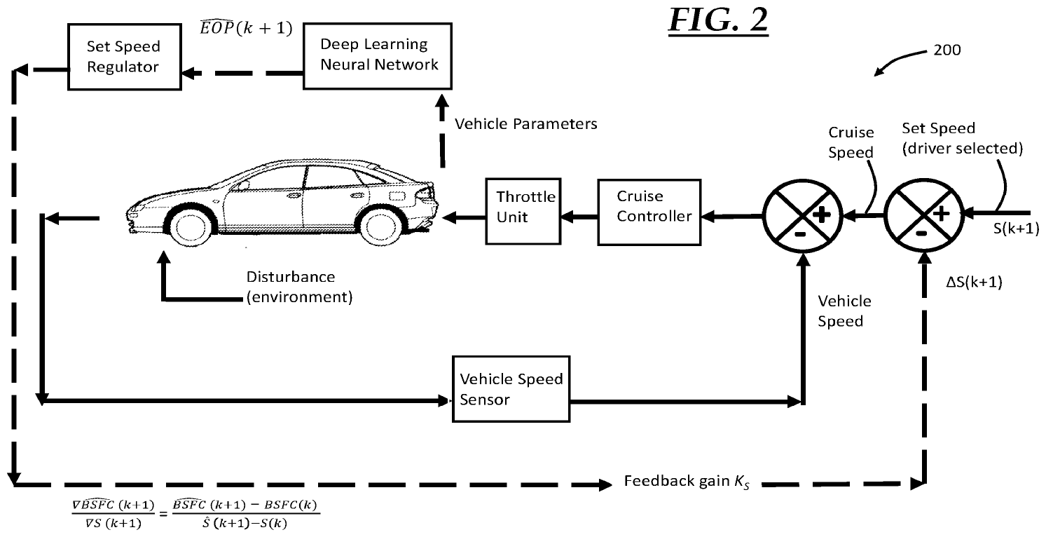

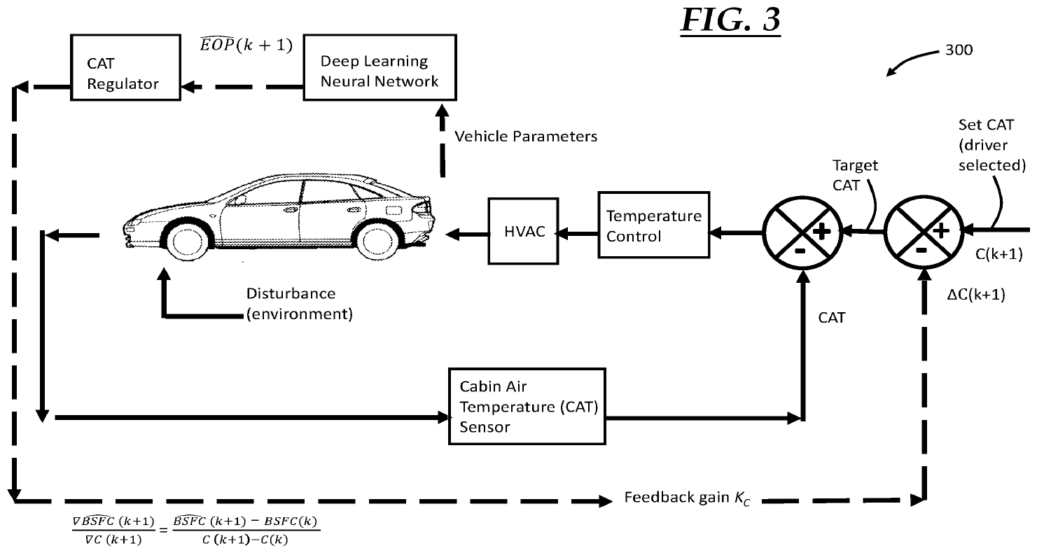

FIGS. 2-3 show examples of feedback control systems 200, 300 that utilize the method 100 to adjust a set vehicle speed (FIG. 2) and a set cabin air temperature (FIG. 3). The construction and operation of the hardware and associated software needed to implement the various components and modules shown in these figures will be apparent to those skilled in the art. In particular, FIG. 2 shows a vehicle set speed control system 200 for which the primary mover performance measure is BSFC and the vehicle parameter is vehicle speed S. The user or vehicle may have a set cruise control speed (“Set Speed” of FIG. 2), which may be used along with a target value indication (“∇S(k+1)” of FIG. 2) to determine a target value (“Cruise Speed” of FIG. 2). With this, the gradient function equation becomes:

$$\frac{∇ ( k + 1 )}{∇ S ( k + 1 )} = \frac{( k + 1 ) - BSFC ( k )}{\hat{S} ( k + 1 ) - S ( k )} \qquad ( 3 A )$$

where BSFC(k) is the BSFC at time step k, [symbol] (k+1) is the predicted or estimated BSFC at time step k+1, S(k) is the current vehicle parameter value for the vehicle speed at time step k, and Ŝ(k+1) is the estimated or predicted vehicle speed for time step k+1. In regard to the example shown in FIG. 2, since a prediction path is established from vehicle speed to BSFC, the loop may be closed by using the gradient of BSFC with respect to vehicle speed in order to fine tune the vehicle's speed. By doing this, the vehicle is continuously operated so that the engine is in a region close to its optimal (minimum) BSFC. Other techniques, such as pulse and glide, achieve “temporary” BSFC optimality during the pulse mode before letting the engine drift far away from the optimal point during the glide mode. According to embodiments, the disclosed technique results in better engine performance over the engine's life, possibly generate better fuel savings, and better for the engine health in the short- and long-term compared to other techniques (such as pulse and glide). All this can translate to reduced total cost of ownership (TCO)—both fuel cost and maintenance cost.

As another example, as shown in FIG. 3, there is shown a vehicle cabin climate control system 300 for which the primary mover performance measure is BSFC and the vehicle parameter is cabin air temperature (CAT). The user or vehicle may have a set CAT (“Set CAT” of FIG. 3), which may be used along with a target value indication (“∇C(k+1)” of FIG. 3) to determine a target value (“Target CAT” of FIG. 3). In this example, the gradient function equation becomes:

$$\frac{∇ ( k + 1 )}{∇ C ( k + 1 )} = \frac{( k + 1 ) - BSFC ( k )}{\hat{C} ( k + 1 ) - C ( k )} \qquad ( 3 B )$$

where BSFC(k) is the BSFC at time step k, [symbol] (k+1) is the predicted or estimated BSFC at time step k+1, C(k) is the vehicle parameter value for the vehicle CAT at time step k, and Ĉ(k+1) is the estimated or predicted vehicle CAT value for time step k+1. In regard to the example shown in FIG. 3, since a prediction path is established from cabin air temperature (CAT) to BSFC, the loop may be closed by using the gradient of BSFC with respect to CAT in order to fine tune the vehicle's CAT. By doing this, the vehicle is continuously operated so that the engine is in a region close to its optimal (minimum) BSFC. According to embodiments, the disclosed technique results in better engine performance over the engine's life, possibly generate better fuel savings, and better for the engine health in the short-and long-term. All this translates to reduced total cost of ownership (TCO)—both fuel cost and maintenance cost.

The target value indication, which may be represented as [symbol] (k+1) generally (at least in some embodiments), may be determined by solving for this value using Equation (3) above. In some embodiments, this target value indication may specify a vehicle parameter adjustment value that indicates an amount of adjustment or difference between the current vehicle parameter value and the target value.

In one embodiment, a plurality of candidate target values are obtained and, for each candidate target value, a predicted primary mover performance measure, such as a predicted or estimated BSFC, is determined based on the candidate target value, such as through using a deep learning neural network, such as the one disclosed in Kolachalama, S. and Lakshmanan, S., “Using Deep Learning to Predict the Engine Operating Point in Real-Time,” SAE Technical Paper 2021-01-0186, 2021, doi:10.4271/2021-01-0186. These plurality of predicted primary mover performance measure may be referred to as a set of predicted primary mover performance measures. In other embodiments, a multivariate time-series estimation may be carried out for determining the set of predicted primary mover performance measures, which may be a linear prediction technique, such as auto-regressive moving average (ARMA) technique, or a non-linear prediction technique, such as a Bayesian technique.

Table 1 below shows an exemplary values for an example scenario in which the vehicle parameter is vehicle speed, such as is shown in the example of FIG. 2.

TABLE 1

| Ŝ (k + 1) | S(k) | ∇S (k + 1) | BSFC(k) | [symbol] (k + 1) | ∇ [symbol] (k + 1) | $\frac{∇ ( k + 1 )}{∇ S ( k + 1 )}$ |
|---|---|---|---|---|---|---|
| 67 | 70 | −3 | 10 | 9 | −1 | 0.333333 |
| 68 | 70 | −2 | 10 | 6 | −4 | 2 |
| 69 | 70 | −1 | 10 | 12 | 2 | −2 |
| 70 | 70 | 0 | 10 | 10 | 0 | X |
| 71 | 70 | 1 | 10 | 11 | 1 | 1 |
| 72 | 70 | 2 | 10 | 8 | −2 | −1 |
| 73 | 70 | 3 | 10 | 10 | 0 | 0 |

The first column on the left is for Ŝ(k+1), which defines a set of candidate target values, and, in this example, are vehicle speed values representing the vehicle speed in miles per hour (mph)—for example, the first data row is for the candidate target value of 67 mph. The set of candidate target values may be predetermined based on static values or determined at runtime (such as during processing of the method 100) based on the current vehicle parameter value. In the present example of Table 1, the current vehicle parameter value S(k) is 70 mph, and the next column, ∇S(k+1), shows a difference between the candidate target value and the current vehicle parameter value. The set of candidate target values, which range at 1 mph increments from 67 mph to 73 mph as shown in Table 1, may be selected based on the current vehicle parameter value, which is 70 mph. The set of candidate target values were selected as those values +/−3 mph as the current vehicle parameter value. In another example, the set of candidate target values may be based on a set cruise control speed (“Set Speed” of FIG. 2), in addition to or in lieu of being based on the current vehicle parameter value. For example, the candidate target values may be selected as those integer mph values between the current vehicle speed (the current vehicle parameter value) and the set cruise control speed. A variety of various rules, logic, or heuristics, which may be tailored to the specific type of vehicle parameter, may be used for defining the set of candidate target values, at least according to some embodiments.

In the present example of Table 1, the current primary mover performance measure BSFC(k) is 10. For each candidate target value in the set of candidate target values, a predicted primary mover performance measure is determined using the candidate target value, the current primary mover performance measure, and the current vehicle parameter value. The predicted primary mover performance measure, which may be a predicted BSFC, may be predicted or estimated using a deep learning neural network, such as the one disclosed in Kolachalama, S. and Lakshmanan, S., “Using Deep Learning to Predict the Engine Operating Point in Real-Time,” SAE Technical Paper 2021-01-0186, 2021, doi:10.4271/2021-01-0186. As mentioned above, in other embodiments, a multivariate time-series estimation may be carried out for determining the set of predicted primary mover performance measures, which may be a linear prediction technique, such as auto-regressive moving average (ARMA) technique, or a non-linear prediction technique, such as a Bayesian technique.

Once the set of predicted primary mover performance measure is determined, then the difference between each predicted primary mover performance measure (in this example, [symbol] (k+1)) and the current primary mover performance measure BSFC(k) is determined, as shown in the ∇ [symbol] (k+1) column. Then, for each candidate target value (each row in Table 1 in this example), [symbol] (k+1) is divided by ∇S(k+1) to get the value of the last row. It should be noted that the candidate target value of 70 mph equals the current vehicle parameter value of 70 mph as so the denominator is 0 for this. This value (represented by “X” in the table above) may be excluded or treated as a predetermined value, such as 0 or 1. Then, once all of the values of this last row are determined, they may be averaged. This average value, which is 0.0556 (excluding the candidate target value of 70 mph as discussed above) and which is an example of a vehicle parameter adjustment value (and target value indication), may then be used to determine the target value for the vehicle parameter. In this example, a positive number indicates that the vehicle speed should be lowered to improve the BSFC. In another embodiment, the target value may be calculated from the predicted primary mover performance measure, such as through selecting the candidate target value with the lowest predicted BSFC to be the target value that is then used in step 160. Of course, various other methodologies may be used to select the target value based on the predicted primary mover performance measure. The method 100 continues to step 160.

In step 160, the vehicle is operated according to the target value for the vehicle parameter. For example, and according to one embodiment, this includes adjusting the driver set speed, as shown in FIG. 2. In the example of FIG. 3, this includes adjusting the set CAT of the vehicle, such as by adjusting a set temperature of an HVAC system of the vehicle. The method 100 then ends.

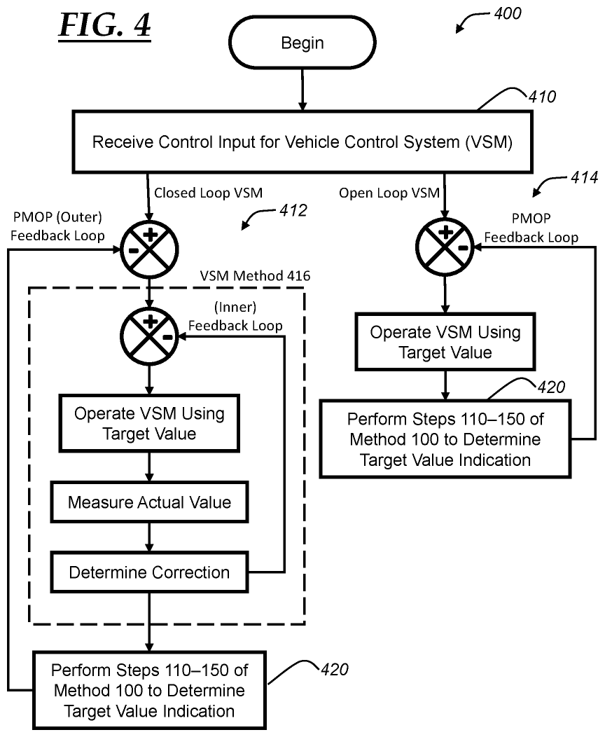

With reference to FIG. 4, there is shown an embodiment of a method 400 of operating a vehicle based on a target value for a vehicle parameter. According to at least some embodiments, the method 400 is carried out by the vehicle control system, which may include one or more processors, such as one or more processors onboard the vehicle. The method 400 begins with step 410, wherein control input is received for a vehicle control system or vehicle system module (collectively, “VSM”), which may be a closed loop control system 412, such as is shown in the examples of FIGS. 2-3, or an open loop control system 414, such as an operator control to operate the blower fan of an HVAC system at a particular power or output level. For example, with respect to the example of FIG. 2, the vehicle control system is a cruise control system that adjusts a cruise speed of the vehicle based on a vehicle speed sensor (an example of an internal closed feedback loop) and a set speed that may be selected by a driver. The driver input indicating the cruise control set speed (or other input indicating the cruise control set speed) may be received as a control input for the vehicle control system 200, such as is indicated at S(k+1) in FIG. 2. With respect to the closed loop control system 412 of FIG. 4, the VSM is operated according to a target value for a vehicle parameter, a current vehicle parameter value is then measured, and then a correction is determined and fed back into the VSM method 416 of the closed loop control system 412. The method 400 proceeds to step 420.

In step 420, the steps 110-150 of the method 100 are carried out to determine a target value indication. The determination of the target value may be based on the control input and the target value indication (which is based on the predicted primary mover performance measure(s)), such as described above. For example, the value 0.0556 may be determined as the target value indication using the method above and this value may be used to determine the target value. In such an example, since this value is positive, it may indicate that the vehicle speed needs to be decreased in order to improve the primary mover performance measure. And, the magnitude of this value may be used to indicate a proportion or extent with which to adjust the current vehicle parameter value and, in this way, this vehicle parameter adjustment value (e.g., the 0.0556 in the example above) is used to determine the target value for the vehicle parameter.

At least in some embodiments, meanwhile and during step 420, the internal or inner control loop (the solid lines in FIGS. 2-3, which correspond to the more-general VSM method 416) may be carried out for the current time step k, while a target value indication for time step k+1 is determined at step 420 using the supplemental vehicle control system described herein (the dashed lines in FIGS. 2-3). The supplemental vehicle control system may thus include a processor and at least one memory storing computer instructions, wherein, when the at least one processor carries out the computer instructions, the supplemental vehicle control system carries out the steps 110-150 to determine the target value indication, which is then used to determine the target value or as the target value. In some embodiments, the supplemental vehicle control system may use or include the same processor and memory as the VSM, but in other embodiments, the devices may be separate. Also, in some embodiments, the supplemental control system, or at least the computer instructions used for the processing of the supplemental control system (e.g., steps 110-150), may be compiled as a software product or module that is separate than that used for the inner feedback loop of the VSM method 416. Thus, according to at least some embodiments, the supplemental control system may be provided and configured separately from the VSM method 416 and may be designed and integrated into existing systems for enhanced control of existing VSMs.

After the target value indication is determined, it may be used to determine the target value that is to be used, which is indicated in FIG. 4 by the arrow extending from step 420 with label PMOP (Outer) Feedback Loop or PMOP Feedback Loop. As mentioned above, the target value indication is or indicates the target value. The target value indication may be used to inform the internal control loop whether to increase or decrease vehicle speed and/or an extent with which to do so. The target value indication may be used along with the control input received at step 410 for determining the target value. Thus, the disclosed method and system provide for supplementary control of a vehicle control system using an outer control loop that may be used to set or determine target values used for operation of the vehicle so as to improve the health and/or performance of the vehicle.

As will now be appreciated by those skilled in the art, the method 100, the method 400, the vehicle control system, and/or the supplementary vehicle control system may be adapted for adding a closed looped control for nearly any vehicle open or closed loop control process so as to adjust that process in accordance with information concerning the vehicle's instantaneous, averaged, or low-pass filtered PMOP so as to improve performance and health of the prime mover. Various specific vehicle applications will be apparent to those skilled in the art.

As but one additional example, the above-described method and control system can be used to determining a target temperature set point for a chiller used to refrigerate or otherwise maintain a relatively low temperature (i.e., below 60 degrees) of cargo in a pulled trailer or compartment of a vehicle. The set point of the chilled space may be used as the vehicle parameter. Again, the method 100 and vehicle control system are applicable to numerous other vehicle parameters and subsystems, as the discussion above provides only a couple examples.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of operating a vehicle based on a target value for a vehicle parameter, wherein the target value is determined based on a closed loop feedback process that uses a predicted primary mover performance measure for a primary mover operating point (PMOP) to determine a target value indication, and wherein the method comprises the steps of:
obtaining a current vehicle parameter value for the vehicle parameter;
determining a current primary mover performance measure for the PMOP;
determining the predicted primary mover performance measure for the PMOP;
determining the target value indication for the vehicle parameter based on the current primary mover performance measure, the predicted primary mover performance measure, and the current vehicle parameter value for the vehicle parameter; and
operating the vehicle according to the target value for the vehicle parameter, wherein the target value for the vehicle parameter is obtained based on the target value indication.

2. The method of claim 1, wherein the determining a current primary mover performance measure for the PMOP step includes determining a current brake specific fuel consumption (BSFC) and wherein the determining a predicted primary mover performance measure for the PMOP step includes determining a predicted BSFC.

3. The method of claim 2, wherein the current BSFC is based on a current engine operating point (EOP), which is characterized at least in part by an instantaneous fuel consumption rate (IFCR), an instantaneous engine torque (IET), and/or an instantaneous engine speed (IES).

4. The method of claim 2, wherein the determining a predicted primary mover performance measure for the PMOP step includes determining a plurality of predicted BSFCs, wherein each predicted BSFC of the plurality of predicted BSFCs corresponds to a candidate target value, and wherein the target value indication is determined based on at least two of the plurality of predicted BSFCs.

5. The method of claim 1, wherein the current primary mover performance measure is based on an electric motor operating point (EMOP).

6. The method of claim 5, wherein the EMOP is characterized at least in part by a state of charge (SoC) of a vehicle battery that is used as a primary power source for powering an electric motor that provides propulsion to the vehicle.

7. The method of claim 5, wherein the current primary mover performance measure is or is based on miles per gallon equivalent (MPGe) and the predicted primary mover performance measure is a predicted MPGe.

8. The method of claim 1, wherein the vehicle parameter is cabin air temperature and wherein the target value for the vehicle parameter is or indicates a target cabin air temperature.

9. The method of claim 1, wherein the vehicle parameter is vehicle speed and wherein the target value indication is or indicates a target vehicle speed.

10. The method of claim 1, wherein the target value indication is determined based on a gradient of the current primary mover performance measure with respect to the vehicle parameter.

11. A vehicle control system, comprising:
at least one electronic processor and memory accessible by the at least one electronic processor, wherein the memory stores computer instructions;
wherein the vehicle control system is configured so that, when the at least one electronic processor executes the computer instructions, the vehicle control system carries out a target value determination process of operating a vehicle based on a target value for a vehicle parameter, wherein the target value is determined based on a closed loop feedback process that uses a predicted primary mover performance measure to determine a target value indication, and wherein the target value determination process includes:
obtaining a current vehicle parameter value for the vehicle parameter;
determining a current primary mover performance measure for the PMOP;
determining the predicted primary mover performance measure for the PMOP;
determining the target value indication for the vehicle parameter based on the current primary mover performance measure, the predicted primary mover performance measure, and the current vehicle parameter value for the vehicle parameter; and
operating the vehicle according to the target value for the vehicle parameter, wherein the target value for the vehicle parameter is obtained based on the target value indication.

12. The vehicle control system of claim 11, wherein the determining a current primary mover performance measure for the PMOP step includes determining a current brake specific fuel consumption (BSFC) and wherein the determining a predicted primary mover performance measure for the PMOP step includes determining a predicted BSFC.

13. The vehicle control system of claim 12, wherein the current BSFC is based on a current engine operating point (EOP), which is characterized at least in part by an instantaneous fuel consumption rate (IFCR), an instantaneous engine torque (IET), and/or an instantaneous engine speed (IES).

14. The vehicle control system of claim 12, wherein the determining a predicted primary mover performance measure for the PMOP step includes determining a plurality of predicted BSFCs, wherein each predicted BSFC of the plurality of predicted BSFCs corresponds to a candidate target value, and wherein the target value indication is determined based on at least two of the plurality of predicted BSFCs.

15. The vehicle control system of claim 11, wherein the current primary mover performance measure is based on an electric motor operating point (EMOP).

16. The vehicle control system of claim 15, wherein the EMOP is characterized at least in part by a state of charge (SoC) of a vehicle battery that is used as a primary power source for powering an electric motor that provides propulsion to the vehicle.

17. The vehicle control system of claim 15, wherein the current primary mover performance measure is or is based on miles per gallon equivalent (MPGe) and the predicted primary mover performance measure is a predicted MPGe.

18. The vehicle control system of claim 11, wherein the vehicle parameter is cabin air temperature and wherein the target value is or indicates a target cabin air temperature.

19. The vehicle control system of claim 11, wherein the vehicle parameter is vehicle speed and wherein the target value indication is or indicates a target vehicle speed.

20. The vehicle control system of claim 11, wherein the target value indication is determined based on a gradient of the primary mover performance measure with respect to the vehicle parameter.
